(19) United States
(12) Patent Application Publication
(10) Pub. No.: US 2013/0251972 A1
(43) Pub. Date: Sep. 26, 2013

(54) POLYIMIDE FILM

(71) Applicant: E I DU PONT DE NEMOURS AND COMPANY, Wilmington, DE (US)

(72) Inventors: NORIKO TOIDA, Aichi (JP); Ryosaku Wagatsuma, Aichi (JP); Satoshi Akiyama, Aichi (JP)

(73) Assignee: E I DU PONT DE NEMOURS AND COMPANY, Wilmington, DE (US)

(21) Appl. No.: 13/849,785

(22) Filed: Mar. 25, 2013

(30) Foreign Application Priority Data
Mar. 26, 2012 (JP) 2012-69884

(51) Int. Cl. C08G 73/10; B32B 15/08; B32B 5/00; C09J 7/02

(52) U.S. Cl. CPC C08G 73/10; C09J 7/0296; B32B 15/08; B32B 5/00
USPC 428/220

(57) ABSTRACT

To provide a flexible metal laminate plate obtained by pasting together an adhesive film, that suppresses the generation of dimensional variation, and a metal foil.

(Resolution Means)

A polyimide film having a manufacturing film width of 1 m or more; an anisotropy index (AI) expressed by formula 1 of 12 or less across the entire width, when the propagation speed V of an ultrasonic pulse is measured at an orientation angle (θ) of the film of 45° and 135°, based on the machine conveyance direction (MD) of the film; and a thermoplastic polyimide layer with a thickness of 0.5 to 20 μm provided on at least one surface.

### BACKGROUND

1. Technical Field

The present invention relates to a polyimide film. Furthermore, the present invention relates to an adhesive film with thermoplastic polyimide on at least one surface of a polyimide film. Furthermore, the present invention relates to a flexible metal laminate plate obtained by pasting a metal foil onto the adhesive film.

2. Related Art

Flexible printed circuits (FPC) are generally formed from various types of insulating materials, and are manufactured by a method that uses an insulation film with flexibility as a substrate, and laminates a metal foil onto the surface of the substrate using various types of adhesive materials by heat and compression bonding. The insulating film is preferably a polyimide film that has excellent heat resistance and electrical insulation. The adhesive material is generally an epoxy or acrylic thermoset adhesive or the like (an FPC that uses these thermoset adhesives is also referred to as a three layer FPC).

An advantage of thermoset adhesives is that adhesion can be achieved at a relatively low temperature. However, it is thought that as requirements become more strict for heat resistance, flexibility, and electrical reliability, there will be applications where a three layer FPC that uses a thermoset adhesive will be difficult to use. Therefore, an FPC has been proposed in which a metal layer is directly provided on an insulating film, or that uses a thermoplastic polyimide on the adhesive layer (also referred to hereafter as a two layer FPC), and the demand for these two layer FPC is expected to grow in the future.

The method for manufacturing a flexible metal laminate plate that is used in a two layer FPC can be a cast method where polyamic acid, which is a precursor of polyimide, is spread and applied onto a metal foil, after which imidization is performed; a metalizing method where a metal layer is directly formed on a polyimide film by sputtering or plating; or a laminating method where a polyimide film and a metal foil are bonded together with a thermoplastic polyimide therebetween. Of these, the laminating method is advantageous from the perspective of accommodating a wider range of metal foil thicknesses than the cast method, and having lower-equipment costs than the metalizing method. The equipment for laminating can be a hot roll laminating device that continuously laminates while unrolling material on a roll or a double belt press device, and the like. Of these, the hot roll laminating method can be more preferably used from the perspective of productivity.

Because a thermoset resin is used in the adhesive layer when fabricating a conventional three layer FPC using the laminating method, laminating can be performed at a temperature below 200° C. (Japanese Unexamined Patent Application Publication No. H9-199830 (patent document 1)). In contrast, two layer FPC uses thermoplastic polyimide as the adhesive layer, so a temperature of 200° C. or higher is required to demonstrate thermal fusion adhesion, and in some cases, a high-temperature approaching 400° C. must be applied. As a result, residual warping will occur in the flexible metal laminate plate obtained by laminating, and therefore dimensional variation will occur when wiring is formed by etching, or when solder reflow is performed in order to mount components.

One example of the laminating method in particular is a method where an adhesive layer containing thermoplastic polyimide is provided on a polyimide film, polyamic acid, which is a precursor of thermoplastic polyimide, is spread and applied, and then imidization is conducted by continuous heating, and then a metal foil is pasted thereon. However, because heat and pressure are both continuously applied not only during the imidization process, but also when the metal layer is pasted on, the material is often placed in a heated environment with tensile force applied. As a result, when etching the metal foil from the flexible metal laminate plate, this warping is relieved when heating by solder reflow, and dimensional variation often occurs before and after these processes.

In recent years, the miniaturization of wiring provided on boards has progressed, mounted components have become smaller, and higher density components have been used in order to achieve smaller, lighter weight electronic equipment. Therefore, if the dimensional variation is large after forming the microscopic wiring, the position for placing the components as stipulated in the design stage will shift, which is problematic because favorable contact between the components and the board will not be achieved. Therefore, there are many requirements of the polyimide film, and for example, some physical property requirements of the polyimide film include having a linear expansion coefficient similar to metal and the ability to further reduce dimensional variation.

Until now, the dimensional variation of a flexible metal laminate plate was considered critical only in the machine conveyance direction (MD direction) of the film and the film transverse direction (TD direction), but as the miniaturization of wiring proceeds, the dimensional variation of the flexible metal laminate plate is required not only in the MD and TD directions, but also in the directions 45° to the left and right of the MD, and flexible metal laminate plates that satisfy these requirements are expected.

In Japanese Unexamined Patent Application Publication No. 2007-91947 (patent document 2), the dimensional variation ratio in a direction approaching 45° to the left and right of the MD direction should be within a range of −0.10 to +0.10%, but in recent years, even further miniaturized wiring has been required, and a dimensional change ratio of −0.10 to +0.10% has become insufficient.

### BACKGROUND DOCUMENTS

### Patent Documents

Patent Document 1: Japanese Unexamined Patent Application Publication No. H9-199830

Patent Document 2: Japanese Unexamined Patent Application Publication No. 2007-91947

### OVERVIEW OF THE INVENTION

### Problems to be Solved by the Invention

In light of the foregoing problems, an object of the present invention is to provide a flexible metal laminate plate obtained by pasting together an adhesive film, which suppresses the generation of dimensional variation, and a metal foil.

### SUMMARY

As a result of diligent research to resolve the aforementioned problems, the present inventors discovered that dimensional variation that occurs during the manufacturing process of FCCL or FPC can be suppressed, and in particular the dimensional variation at a diagonal direction of the film can be suppressed if the anisotropy index AI (45, 135) value expressed by formula 1 is 12 or less across the entire width, with regards to film orientation angles (θ) of 45° and 135° based on the machine conveyance direction (MD) of the film. The present invention was achieved by proceeding with research based on this finding.

In other words, the present invention relates to the following invention.

[1] A polyimide film having a manufacturing film width of 1 m or more; an anisotropy index (AI) expressed by formula 1 below of 12 or less across the entire width, when the propagation speed V of an ultrasonic pulse is measured at an orientation angle (θ) of the film of 45° and 135°, based on the machine conveyance direction (MD) of the film; and a thermoplastic polyimide layer with a thickness of 0.5 to 20 μm provided on at least one surface.

AI (45, 135)=|(V45̂2−V135̂2)/(V45̂2+V135̂2)/2)×100| (formula 1)

[2] The polyimide film according to [1], wherein two points are selected 200 mm in from both ends of the film width in a straight line in a direction perpendicular to the machine conveyance direction (MD) of the film, one point is selected within ±200 mm of the center part of a line that includes the aforementioned two points, and another two arbitrary points are selected, and the anisotropy Index (AI) is 12 or less for at least all of these five points.

[3] The polyimide film according to [1] or [2], wherein the polyimide film is stretched by biaxial stretching in the machine conveyance direction (MD) and the transverse direction (TD) of the film, and stretching in the MD direction is two stage stretching.

[4] The polyimide film according to [3], wherein during the two-stage stretching in the MD direction, the ratio of the stretch factor of the first stage with regards to the total stretch factor in the MD direction is 40% or higher.

[5] The polyimide film according to [3] or [4], wherein the stretch factor in the TD direction is 1.10 times or more to 1.5 times or less than the total stretch factor in the MD direction.

[6] The polyimide film according to any one of [1] through [5], wherein the polyimide film is manufactured from an aromatic amine component where the molar ratio of 4,4′-diamino diphenyl ether and/or 3,4′-diamino diphenyl ether and paraphenylene diamine is in a range of 69/31 to 90/10, and a polyamic acid containing an acid anhydride component where the molar ratio of pyromellitic acid dianhydride and 3,3′,4,4′-biphenyl tetracarboxylic acid dianhydride is in a range of 80/20 to 60/40; or is derived from polyamic acid having an aromatic diamine component that is paraphenylene diamine and an acid anhydride component that is 3,3′,4,4′-biphenyl tetracarboxylic acid dianhydride where the molar ratio between the aromatic diamine component and the acid anhydride component is in a range of 40/60 to 60/40.

[7] An adhesive polyimide film obtained by applying, heating, and drying an organic solvent solution of thermoplastic polyimide or an organic solvent solution of polyamic acid, which is a precursor of thermoplastic polyamide, onto the polyimide film according to any one of [1] through [6].

[8] A flexible metal laminate plate, obtained by pasting a metal foil onto the adhesive polyimide film of [7].

### Effect of the Invention

The polyimide film and the flexible metal laminate plate of the present invention suppress the occurrence of dimensional variation, and can effectively suppress the occurrence of dimensional variation in the laminating method in particular. Specifically, the dimensional variation ratio before and after removing the metal foil can be minimized in the directions 45° to the left and right of the film machine conveyance direction (MD direction), and can minimize the difference in the dimensional variation in the direction 45° to the right and 45° to the left of the MD direction, and for example, the range can be 0.05% or less. Furthermore, the FPC and the like formed with miniaturized wiring can be favorably used because problems with positional shifting and the like can be improved. In particular, if an adhesive film with a width of 1 m or more is continuously produced, not only will the aforementioned dimensional variation ratio be small, but also there will be an effect such that the dimensional variation ratio will be stable across the entire width of the film.

### BRIEF DESCRIPTION OF THE DRAWINGS

FIG. 1 depicts the relationship between AI (45, 135) and the dimensional variation ratio.

FIG. 2 is a schematic diagram depicting the orientation axis and the angle of orientation (θ). The white on black arrow depicts the machine conveyance direction (MD) and the traverse direction (TD) of the film.

FIG. 3 converts the ultrasonic speed at each angle to a radar graph, and the orientation axis is drawn from this to determine the orientation angle (θ). The white on black arrow depicts the machine conveyance direction (MD) of the film.

FIG. 4 is a schematic diagram illustrating the measurement positions of the orientation angle (θ) of the polyimide film of the present invention. The white on black arrow depicts the machine conveyance direction (MD) of the film.

### DETAILED DESCRIPTION

The present invention is described below in detail. The polyimide film of the present invention has a manufacturing film width of 1 m or more, and the anisotropy index (AI) expressed by formula 1 is 12 or less across the entire width when the propagation speed V of an ultrasonic pulse is measured at an orientation angle (θ) of the film of 45° and 135°, based on the machine conveyance direction (MD) of the film, and a thermoplastic polyimide layer with a thickness of 0.5 to 20 μm is provided on at least one surface.

The propagation speed (also referred to as ultrasonic speed) V of the ultrasonic pulse in formula 1 of the present invention was measured using a Sonic Sheet Tester SST-2500 manufactured by Nomura Trading. When using the SST-2500, the ultrasonic speed in 16 directions is automatically measured at increments of 11.25° in the surface direction of 0 to 180° of the film (0° is parallel to the MD direction). Of the speeds in the various directions obtained, the anisotropy index (AI) expressed by formula 1 is determined from the ultrasonic speeds V45 and V135 at 45° and 135° based on the MD direction.

AI (45, 135)=|(V45̂2−V135̂2)/(V45̂2+V135̂2)/2)×100| (formula 1)

A smaller value for the AI (45, 135) that is obtained indicates that the film has less anisotropy on the diagonal lines. With the present invention, the anisotropy index is 12 or less, but from the perspective of suppressing the occurrence of dimensional variation, the anisotropy index is more preferably 11 or less, even more preferably 8 or less, and particularly preferably 6 or less.

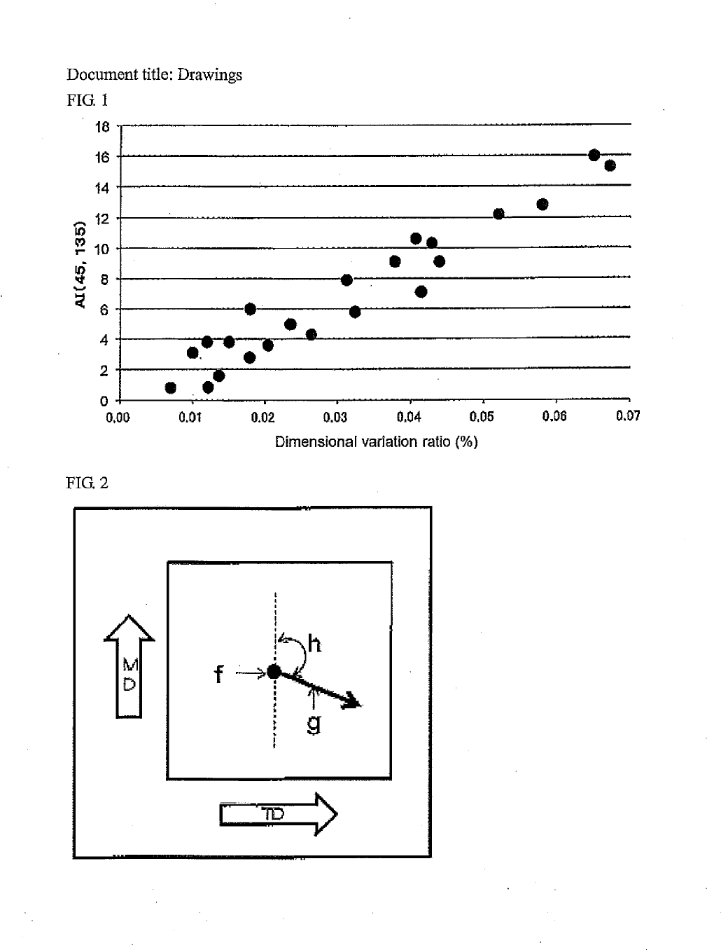

As a result of diligent research, the present inventors discovered a correlation, as indicated in FIG. 1, between the AI (45, 135) of a film and the dimensional variation ratio of a flexible metal laminate plate that uses the adhesive film, and specifically, when the value of AI (45, 135) of the film increases, the dimensional variation of the flexible metal laminate plate that uses this adhesive film will also increase.

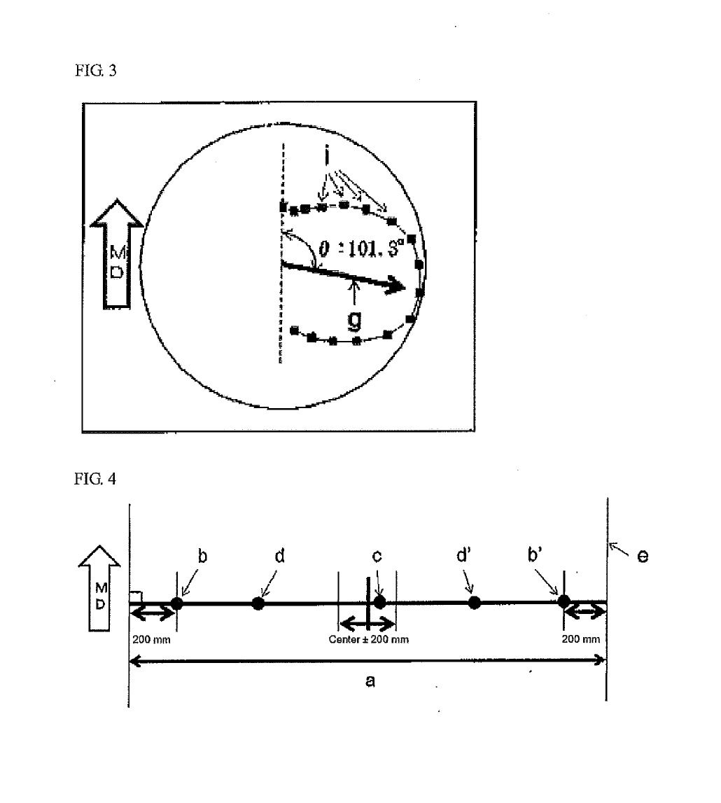

The orientation angle of the present invention was measured using a sonic sheet tester (SST-2500) manufactured by Nomura Trading. In the present invention, the orientation angle (θ) refers to the direction of the axis of orientation, and as depicted in FIG. 2, indicates the angle of the side where the baseline is rotated in the clockwise direction, where the machine conveyance direction (MD) of the film is the baseline at 0°. When using the SST-2500, the ultrasonic speed in 16 directions is automatically measured at increments of 11.25° in the surface direction of 0 to 180° of the film (0° is parallel to the MD direction). A pattern diagram such as FIG. 3 is drawn by radar graphing the speed in each of the directions obtained (using the graphing function of Microsoft Excel). The line drawn from the center of the circle to the furthest section of the pattern diagram is the orientation axis (g), and the angle (θ) of the orientation axis from the baseline was measured using the MD as the baseline to determine the orientation angle.

Regarding the flexible metal laminate plate that is obtained using the polyamide film of the present invention, the dimensional variation ratio before and after removing the metal foil is preferably in a range of −0.05% to +0.05% in the directions 45° to the right and 45° to the left of the MD direction, but a range of −0.04% to +0.04% is more preferable, and a range of −0.025% to +0.025% is particularly preferable. Furthermore, the difference in the dimensional variation ratios in the directions 45° to the right and 45° to the left is preferably 0.01% or less, and more preferably 0.005% or less. The dimensional variation ratio before and after removing the metal foil is expressed as a ratio of the difference between a prescribed dimension in the flexible metal laminate plate before the etching process and a prescribed dimension after the etching process to the prescribed dimension before the etching process.

If the dimensional variation ratio is outside of this range, the dimensional variation will be large after forming the microscopic wiring on the flexible metal laminate plate and when mounting components, and deviation from the component mounting position specified in the design stage may occur. As a result, there is a possibility that a favorable connection will not be achieved between the mounted components and the board. In other words, if the dimensional variation ratio is within the aforementioned range, this can be regarded as there being no obstacles to mounting the components.

The method for measuring the aforementioned dimensional variation ratio is not particularly limited, and any conventionally known method that can measure a change in dimension that occurs in the flexible metal laminate plate before and after etching or heating can be used.

Note, the specific conditions of the etching process when measuring the dimensional variation ratio are not limited in particular. In other words, the etching conditions will vary depending on the type of metal foil, and the shape of the pattern wiring that is formed, and the like, and therefore conditions for the etching process when measuring the dimensional variation ratio of the present invention can be any conventionally known conditions.

Furthermore, the orientation angle (θ) of the polyamide film of the present invention is preferably in a range of 90°±23°, and more preferably within a range of 90°±12°, using the machine conveyance direction (MD) as a baseline. Herein, the orientation angle 90° occurs when the orientation axis is parallel to the film transverse direction (TD). In other words, if the orientation angle is within the aforementioned range, the orientation axis will face the TD direction across the entire width of the film, and the variation will be small. Therefore, the physical properties of the film will be similar at any position, and the dimensional stability in the TD direction will be high, which is preferable. If the orientation angle (θ) exceeds 90±23°, the TD orientation of the film will be disrupted, and the physical properties will change, which is not preferable.

The method for manufacturing the polyimide film of the present invention is not particularly limited, and can include for example (1) a step of obtaining a polyamic acid solution by polymerizing an aromatic diamine component with an acid anhydride component in an organic solvent, (2) a step of obtaining a gel film by a cyclization reaction of the polyamic acid solution obtained in step (1), and (3) a step of performing biaxial stretching in the MD and TD directions where MD stretching (hereinafter also referred to as longitudinal stretching) of the gel film obtained in step (2) is done in two stages, and the stretching ratio in the TD direction is 1.10 times or more to 1.50 times or less than the total stretching ratio in the MD direction.

Step (1) is a step of obtaining a polyamic acid solution by polymerizing an aromatic diamine component and an acid anhydride component in an organic solvent.

The aforementioned aromatic diamine is not particularly limited so long as the effect of the present invention is not hindered, and specific examples include paraphenylene diamine, methaphenilene diamine, benzidine, paraxylene diamine, 4,4′-diaminodiphenyl ether, 3,4′-diaminodiphenyl ether, 4,4′-diaminodiphenyl methane, 4,4′-diaminodiphenyl sulfone, 3,3′-dimethyl-4,4′-diaminodiphenyl methane, 1,5-diaminonaphthalene, 3,3′-dimethoxybenzidine, 1,4-bis(3-methyl-5-aminophenyl)benzene and amide forming derivatives thereof. Of these, the amount of diamines such as paraphenylene diamine and 3, 4′-diaminodiphenyl ether that have an effect to increase the tensile elasticity of the film is adjusted, and the tensile elasticity of the polyimide film eventually obtained is preferably 4.0 GPa or higher. These aromatic diamines can be used individually, or two or more types can be used in combination. Of these aromatic diamines, paraphenylene diamine, 4,4′-diaminodiphenyl ether, and 3,4′-diaminodiphenyl ether are preferable. If paraphenylene diamine and 4,4′-diaminodiphenyl ether and/or 3,4′-diaminodiphenyl ether are used in combination, the ratio of (i) 4,4′-diaminodiphenyl ether and/or 3,4′-diaminodiphenyl ether and (ii) paraphenylene diamine is more preferably 69/31 to 90/10 (molar ratio), and is especially preferably 70/30 to 85/15 (molar ratio) for use.

The acid anhydride component is not particularly limited so long as the effect of the present invention is not hindered, and specific examples include the acid anhydrides of pyromellitic acid, 3,3′,4,4′-biphenyl tetracarboxylic acid, 2,3′,3,4′-biphenyl tetracarboxylic acid, 3,3′,4,4′-benzophenone tetracarboxylic acid, 2,3,6,7-naphthalene dicarboxylic acid, 2,2-bis(3,4-dicarboxyphenyl)ether, pyridine-2,3,5,6-tetracarboxylic acid, and amide forming derivatives thereof, but acid dianhydride of aromatic tetracarboxylic acid is preferable, and pyromellitic acid dianhydride and/or 3,3′,4,4′-biphenyl tetracarboxylic acid trianhydride are particularly preferable. These acid anhydride components can be used individually, or two or more types can be used in combination. Furthermore, of these, the use of a blend of pyromellitic dianhydride and 3,3′,4,4′-biphenyl tetracarboxylic acid dianhydride in a ratio of 80/20 to 60/40 (molar ratio) is more preferable, and a ratio of 75/25 to 65/35 (molar ratio) is especially preferable.

In the present invention, the organic solvent that is used when forming the polyamic acid solution is not particularly restricted, and examples include: sulfoxide solvents such as dimethyl sulfoxide, diethyl sulfoxide, and the like; formamide solvents such as N,N-dimethylformamide, N,N-diethylformamide, and the like; acetamide solvents such as N,N-dimethyl acetamide, N,N-diethyl acetamide, and the like; pyrrolidone solvents such as N-methyl-2-pyrrolidone, N-vinyl-2-pyrrolidone, and the like; phenol solvents such as phenol, o-, m-, and p-cresol, xylenol, halogenated phenol, catechol, and the like; and a non-protonic polar solvents such as hexamethyl phosphoramide, gamma-butyrolactone, and the like. These solvents are preferably used individually or as mixtures, but an aromatic hydrocarbon such as xylene or toluene or the like can also be used.

The polymerization method can be any commonly known method without any limitations in particular, and examples include (i) a method of polymerizing by adding the whole amount of the aforementioned aromatic diamine component to an organic solvent, and then adding the acid anhydride component such that the amount becomes equivalent to the whole amount of the aromatic diamine component; (ii) a method of polymerizing by adding the whole amount of the aforementioned acid anhydride component to the solvent, and then adding the aromatic diamine component such that the amount becomes equivalent to the whole amount of the acid anhydride component; (iii) a method of polymerizing by adding one of the aromatic diamine components to the solvent, mixing for the necessary time to react at a ratio such that the acid anhydride component becomes 95 to 105 mol % relative to the reaction components, and then adding another aromatic diamine component followed by the addition of an acid anhydride component so that the total amount of aromatic diamine component and acid anhydride component are essentially equivalent; (iv) a method of polymerizing by adding an acid anhydride component to the solvent, mixing for the necessary time to react at a ratio such that one of the aromatic diamine components becomes 95 to 105 mol % relative to the reaction components, after which the acid anhydride component is added, followed by the addition of another aromatic diamine component such that the total amount of aromatic diamine component and acid anhydride component are essentially equivalent; and (v) a method where a polyamic acid solution (A) is prepared by reacting one of the aromatic diamine components and the acid anhydride component in the solvent such that one of the components is in excess, and then a polyamic acid solution (B) is prepared by reacting the other aromatic diamine component and acid anhydride component in a separate solvent such that one of the components is in excess, and next, the obtained polyamic acid solutions (A) and (B) are mixed together, and polymerized to completion; and (vi) a method where if the aromatic diamine component is in excess when preparing the polyamic acid solution (A), the acid anhydride component is in excess when preparing the polyamic acid solution (B), and if the acid anhydride component is in excess when preparing the polyamic acid solution (A), the aromatic diamine component is in excess when preparing the polyamic acid solution (B), and the polyamic acid solutions (A) and (B) are mixed such that the total amount of aromatic diamine component and acid anhydride component used in the reaction are essentially equivalent.

The polyamic acid solution obtained in this manner preferably contains 5 to 40 weight % of solid content, and more preferably 10 to 30 weight %. Furthermore, the viscosity of the polyamic acid solution is a figure that is measured by a rotating viscosity meter method using a Brookfield viscometer in accordance with JIS K6726-1994 and is not particularly limited, but is preferably 10 to 2000 Pa-s (100 to 20,000 poise), and from the perspective of providing a stabilized solution, the viscosity is more preferably 100 to 1000 Pa-s (1000 to 10,000 poise). Furthermore, the polyamic acid in the organic solvent solution may be partially imidized.

The polyamic acid solution of the present invention may also contain chemically inert organic filler or inorganic filler such as titanium oxide, find silica, calcium carbonate, calcium phosphate, calcium hydrogen phosphate, polyimide filler, and the like, if necessary in order to provide slip properties to the film.

The inorganic filler (inorganic particles) that are used in the present invention are not particularly restricted, but inorganic fillers where the particle diameter of all particles is within a range of 0.005 μm or higher and 2.0 μm or less is preferable, and an inorganic filler where the particle diameter of all of the particles is within a range of 0.01 μm or more and 1.5 μm or less is more preferable. The particle size distribution (volumetric basis) is not particularly restricted, but an inorganic filler where particles with a particle diameter of 0.01 μm or more and 0.90 μm or less accounts for 80% or more of all particles by volume is preferable, and from the perspective of achieving excellent slip properties, and inorganic filler where particles with a particle size of 0.10 μm or more and 0.75 μm or less accounts for 80% or more of the total particles by volume is more preferable. If the average particle diameter is 0.05 μm or less, the slip effect of the film will be inferior, which is not preferable, but if the average particle diameter is 1.0 μm or more, locally large particles will occur, which is not preferable. The aforementioned particle size distribution, average particle diameter, and particle diameter range can be measured using a laser diffraction/diffusion type particle size distribution measuring device LA-910 produced by Horiba Ltd. The average particle diameter indicates the volumetric average particle size.

Although not particularly restricted, the inorganic filler that is used with the present invention is preferably dispersed uniformly in the film at a ratio of 0.03 weight % or more and less than 1.0 weight %, with regards to the weight of the polyamic acid solution, and from a perspective of slip effect, a ratio of 0.30 weight % or higher and 0.80 weight % or lower is more preferable. If the amount is 1.0 weight % or higher, the mechanical strength will be lower, but if the amount is 0.03 weight % or lower, sufficient slip effect will not be achieved, which is not preferable.

Step (2) is a step of obtaining a gel film by cyclization reaction of the polyamic acid solution obtained in step (1). The method of the cyclization reaction of the polyamic acid solution is not particularly restricted, but specific examples include (i) a method of casting the polyamic acid solution to form a film, and then heating to cause a cyclization reaction to form a gel film (thermal cyclization method), or (ii) a method of mixing a cyclization catalyst and a transfer agent into the polyamic acid solution and then chemically removing the ring to form a gel film and then heating (chemical cyclization method) at the like, but the latter method is preferable from the perspective of uniformly suppressing dimensional variation in combination with other component requirements of the polyimide film that is obtained. The polyamic acid solution may also contain a gel retardant. The gel retardant is not particularly restricted, but acetyl acetone or the like can be used.

The cyclization catalyst is not particularly restricted, but examples include aliphatic tertiary amines such as trimethyl amine, triethyl amine, and the like; aromatic tertiary amines such as dimethyl aniline and the like; heterocyclic tertiary amines such as isoquinoline, pyridine, beta-picoline, and the like, but one or more hetero cyclic tertiary amine selected from the group consisting of isoquinoline, pyridine, and beta-picoline is preferable. The transfer agent is not particularly restricted, but examples include aliphatic carboxylic acid anhydrides such as acetic anhydride, propionic anhydride, butyric anhydride, and the like; and aromatic carboxylic acid anhydrides such as benzoic anhydride, and the like, but acetic anhydride and/or benzoic anhydride are preferable. The amount of these cyclization catalyst and transfer agents is not particularly restricted, but approximately 10 to 40 weight % of each is preferable, and approximately 15 to 30 weight % is more preferable, based on 100 weight % of the polyamic acid solution.

The polyamic acid solution or the mixture solution containing polyamic acid solution and cyclization catalyst and transfer agent is formed into a film by passing through a slit shaped die, is spread on a heated supporting member, a heated cyclic reaction is performed on the supporting member to form a gel film with self-supporting properties which is then removed from the supporting member.

The supporting member is not particularly restricted, but examples include a metal (for example stainless steel) rotating drum, endless belt, or the like, and the temperature of the supporting member is not particularly restricted, but is controlled by (i) a liquid or gas heat carrier, or (2) a radiant heat source such as an electric heater or the like.

The gel film can be obtained by subjecting the polyamic acid solution or the mixture solution where a cyclization catalyst and a transfer agent are mixed with the polyamic acid solution to a cyclization reaction by heating to a temperature that is preferably 30 to 200° C., more preferably 40 to 150° C., by the heat received from the supporting member, or the heat received from a heat source such as hot air or an electric heater or the like, drying the volatile components such as the organic solvent in order to provide self-supporting properties, and then removing the film from the supporting member.

Step (3) is a step of biaxially stretching the gel fill obtained in step (2) in the MD and TD directions, where stretching in the MD direction is performed by a two-stage stretching, and the stretching ratio in the TD direction is 1.10 times or more and 1.5 times or less than the total stretch factor in the MD direction.

The gel film that is removed from the supporting member is stretched in the direction of travel (MD) while controlling the speed of travel by a rotating roller. The rotating roller must have sufficient gripping strength to control the travel speed of the gel film, and the rotating roller is preferably a nip roller that combines a metal roller and a rubber roller, a vacuum roller, a multistage tensile cut roller, or a vacuum suction type suction roller, and the like.

Biaxial stretching is performed in step (3). The order of performing the biaxial stretching is not particularly restricted, but preferably the transverse directions (TD) stretching (hereinafter also referred to as lateral stretching) is performed after the machine conveyance direction (MD) stretching (longitudinal stretching). Furthermore, a process of longitudinal stretching, heating, and then lateral stretching, or a process of longitudinal stretching and then lateral stretching in parallel with heating is more preferable from the perspective that the dimensional variation can be uniformly controlled in combination with other component requirements.

Stretching in the MD direction (longitudinal stretching) during the biaxial stretching process is performed in two stages in order to control the dimensional variation of the polyimide film together with other component requirements. When performing two-stage stretching in the MD direction, the stretching ratio of the first stage (hereinafter also referred to as longitudinal stretching ratio) is not particularly restricted, but is preferably 1.02 times or more and 1.3 times or less, but from the perspective of uniformly controlling the dimensional variation, 1.04 times or more and 1.1 times or less is more preferable. The second stage stretching ratio in the MDA direction is preferably 1.02 times or more and 1.3 times or less, but more preferably 1.04 times or more and 1.1 times or less, from the perspective of satisfying other component requirements. Furthermore, with the present invention, the ratio between the stretching ratio of the first stage stretching with regards to the total stretching ratio in the MD direction is preferably 40% or more of the total stretching ratio in the MD direction, from the perspective of uniformly controlling the dimensional variation in combination with other component requirements, and is more preferably 50% or higher and 80% or lower from the perspective of better controlling the dimensional variation. Herein, the method for calculating the ratio of the stretching ratio of the first stretching with regards to the total stretching ratio in the MD direction is presented below.

Ratio of stretching ratio of first stage stretching=(stretching ratio of first stage stretching−1)/(total stretching ratio−1)×100 (Equation 1)

For example, a stretching ratio of 1.1 times indicates stretching of 0.1 times with regards to a base length of 1 (length before stretching). Therefore, the calculation is performed by subtracting 1 from the stretching ratio. The total stretching ratio in the MD direction is not particularly restricted, but a ratio of 1.04 times or higher and 1.4 times or lower is preferable, and 1.05 times or higher and 1.3 times or lower is more preferable. The MD stretching temperature is not particularly restricted, but is preferably approximately 60 to 100° C., more preferably approximately 65 to 90° C. The empty stretching speed is not particularly restricted, but when 2 stage stretching is performed, the stretching speed of the first stage of the two stage stretching is preferably approximately 1%/minute to 20%/minute, more preferably approximately 2%/minute to 10%/minute, from the perspective of uniformly controlling the dimensional variation in combination with other component requirements. The stretching speed of the second stage of the two-stage stretching is preferably approximately 1%/minute to 20%/minute, more preferably 2%/minute to 10%/minute. During two-stage stretching in the empty direction, the stretching time of each stage is not particularly restricted, but is approximately 5 seconds to 5 minutes, preferably 10 seconds to 3 minutes. The pattern for longitudinal stretching can be a method of stretching from a stretch factor of 1 to the stretching ratio at one time, a method of gradually stretching, a method of gradually stretching by a non-constant amount, a method of gradually stretching by a constant amount, or a method that combines these methods, but a method where stretching is gradually performed by a constant amount is preferable.

If heating is performed after the MD stretching, the heating temperature is not particularly restricted, but the temperature is preferably higher than the temperature during NDA stretching, and is normally approximately 80 to 550° C., preferably approximately 180 to 500° C., and more preferably approximately 200 to 450° C. If the stretching is started when the temperature is below 80° C., the film may be hard and brittle, and there is a possibility that stretching will be difficult. The heating time is preferably 30 seconds to 20 minutes, more preferably 50 seconds to 10 minutes. Furthermore, heating can be performed in multiple stages at different temperatures (2 stages, 3 stages, and the like). For example, if heating is performed by multiple stages, the heating temperature of the first stage is not particularly restricted, but is preferably 80° C. or higher and 300° C. or lower in order to sufficiently remove this solvent, more preferably 100° C. or higher and 290° C. or lower, and even more preferably 120° C. or higher and 285° C. or lower. If multistage heating is performed, the heating temperature of the final stage is not particularly restricted so long as the heating temperature is higher than the heating temperature of the first stage and is set to a different heating temperature than the first stage, and for example, higher than 300° C. and 5500° C. or lower is preferable, 320° C. or higher and 500° C. or lower is more preferable, and 350° C. or higher and 450° C. or lower is even more preferable. If the heating temperature of the first stage is higher than the heating temperature of the final stage, the solvent will rapidly evaporate, the film obtained will be brittle, and will not be practical for use. For the case of multistage heating, the heating time is the same as described above. When heating, a casting furnace with a plurality of blocks (zones of different temperature can be used, or a heating device such as a heating oven or the like can be used. The heating process is preferably performed while securing both ends of the film by a pin type tenter device, clip type tenter device, chuck, or the like. The solvent can be removed by this heating process.

The gel film that has been stretched in the MD direction is introduced to a tenter device, ends in the lateral direction are grasped by tenter clips, and stretching is performed in the transverse direction (TD) while traveling together with the tenter clips. The TD stretch factor (hereinafter also referred to as the lateral stretch ratio)is not particularly restricted, but is preferably 1.35 times or more, and 2.0 times or less, but from the perspective of uniformly controlling the dimensional variation in combination with other component requirements, the stretch factor is more preferably 1.40 times or higher and 1.8 times or less. The stretching ratio in the TD direction refers to lateral stretching in the present example. The TD stretching ratio (lateral stretching ratio) must be set higher than the MDA stretching ratio (longitudinal stretching ratio), and specifically is normally 1.10 times or more and 1.50 times or less than the total stretching ratio in the MD direction, but from the perspective of uniformly controlling the dimensional variation in combination with other components requirements, the ratio is preferably 1.15 times or more and 1.45 times or less. The empty stretching is to stage stretching, and the TD stretching ratio is set to be higher than the empty stretching ratio of the film, and thereby a film can be obtained where the dimensional variation is controlled in combination with other components requirements. TD stretching can be performed after heating, or can be performed before heating, but from the perspective of war uniformly controlling the dimensional variation, stretching his preferably performed in parallel with heating. The stretching time for TD stretching is not particularly restricted, but is approximately 5 seconds to 10 minutes, preferably 10 seconds to 5 minutes. The pattern for lateral stretching can be a method of stretching from a stretch factor of 1 to the lateral stretching ratio at one time, a method of gradually stretching, a method of gradually stretching by a non-constant amount, a method of gradually stretching by a constant amount, or a method that combines these methods. In particular, if lateral stretching and multistage heating are performed in parallel, the TD stretching ratio is preferably set to the maximum stretch factor during the first stage heating process, and then the stretching ratio is gradually reduced. Furthermore, the TD stretching ratio is gradually increased after the first stage heating, and the TD stretching ratio is preferably set to the maximum stretching ratio at the second heating stage, or during the final heating stage.

Furthermore, in order to manufacture a polyimide film with uniform dimensional variation in the film width direction and with the desired dimensional variation across the entire width, it was determined as a result of diligent research that the residual solvent ratio at the time of TD stretching the film has an effect. If the film is stretched in the TD direction after the solvent has been sufficiently removed, the film will be oriented at an angle at the ends of the film because of the tensile force in the MD direction and stretching in the TD direction, but assuming the amount of solvent included in the gel film during the step of obtaining the gel film by cyclization reaction of the polyamic acid solution is 100%, if stretching is performed in the lateral direction (TD) when the residual solvent ratio in the drying step is 50 got 90%, the tensile force and the MD direction will be relieved by the film itself, and a polyimide film with uniform dimensional variation can be produced. Furthermore, from the perspective of better controlling the variation of the dimensional variation, the residual solvent ratio is more preferably 50 to 90% when the lateral stretching ratio is 50%, more preferably, the residual solvent ratio is 50 to 90% when the lateral stretching ratio is 50% and the residual solvent ratio is 50 to 90% when the lateral stretching ratio is 80%, and even more preferably, the residual solvent ratio is 60 got 90% when the lateral stretching is 50% and the residual solvent ratio is 50 to 70% when the lateral stretching ratio is 80%. Measuring the variation in the dimensional variation is performed at the locations depicted in FIG. 3 for example. Specifically, if the manufactured film width is 1 m or larger, two points are selected 200 mm in from both ends of the film which in a straight line in the direction perpendicular to the machine conveyance direction (MD) of the film, one point is selected within +200 mm of the center part of the line that includes the aforementioned two points, and another to arbitrary points are selected to provide at least 5 points.

Next, a second example of the manufacturing method of the polyimide film of the present invention is described below in detail. The second example of the manufacturing method includes for example (1) a step of obtaining a polyamic acid solution by polymerizing an aromatic diamine component with and acid anhydride component in an organic solvent, (2) a step of obtaining a gel film by cyclization reaction of the polyamic acid solution obtained in step (1), and (3) a step of performing biaxial stretching in the MD and TD directions where MD stretching (hereinafter also referred to as longitudinal stretching) of the gel film obtained in step (2)is performed in three or more stages, and the stretching ratio in the TD direction is 1.10 times or more and 1.50 times or less than the total stretching ratio in the MD direction.

In the second manufacturing example, step (3) is a step of biaxially stretching where MD stretching is multistage stretching of the gel film obtained in step (2) using three or more stages, and the stretching ratio in the TD direction is 1.10 times or more and 1.50 times or less than the total stretching ratio in the MD direction.

The gel film that is removed from the supporting member in step (2) is stretched in the direction of travel (MD) while controlling the speed of travel by a rotating roller. The rotating roller must have sufficient gripping strength to control the travel speed of the gel film, and the rotating roller is preferably a nip roller that combines a metal roller and a rubber roller, a vacuum roller, a multistage tensile cut roller, or a vacuum suction type suction roller, and the like.

Biaxial stretching is performed in step (3). The order of biaxially stretching can be the same as the first manufacturing example.

In the second manufacturing example, the MD stretching (longitudinal stretching) of the biaxial stretching process is performed in multiple stages of 3 stages or more. MD stretching (longitudinal stretching) is not particularly restricted so long as being performed in 3 or more stages, and can be performed in 3 stages, 4 stages, 5 stages, or the like, But from the perspective of uniformity of linear thermal expansion coefficient of the film obtained, 3 stage stretching is preferable.

The stretching ratio of each stage in the MD direction is not particularly restricted, and for example, for the case of 3 stage stretching, the stretching ratio of the first stage is not particularly restricted, but is preferably 1.02 times or higher and 1.3 times or lower, more preferably 1.04 times or higher and 1.1 times or lower. The MD stretching ratio of the second stage is preferably 1.005 times or higher and 1.4 times or lower, more preferably 1.01 times or higher and 1.3 times or lower. The MD stretching ratio of the third stage is preferably 1.02 times or higher and 1.3 times or lower, more preferably 1.04 times or higher, and 1.1 times or lower. Furthermore, with the present invention, the ratio between the stretching ratio of the first stage stretching with regards to the total stretching ratio in the MD direction is preferably 40% or more, more preferably 50% or higher and 80% or lower. Furthermore, the ratio of the second stage stretching ratio with regards to the total stretching ratio in the MD direction is preferably 5% or higher, more preferably 8% or higher and 30% or lower. The total stretching ratio in the MD direction is not particularly restricted, but a ratio of 1.04 times or higher and 1.4 times or lower is preferable, and 1.05 times or higher and 1.3 times or lower is more preferable. The calculation method for the ratio of the stretching ratio for each of the MD stretches with regards to the total stretching ratio in the MD direction is as described in the first example.

The MD stretching temperature can be the same as described in the first manufacturing example. The MD stretching speed is not particularly restricted, and the conditions that can provide the desired linear thermal expansion coefficient can be appropriately selected, but for the case of 3 stage stretching, the stretching speed of the first stage of three stage stretching is preferably approximately 1%/minute to 20%/minute, more preferably approximately 2%/minute to 10%/minute. The stretching speed of the second stage of the three-stage stretching is preferably approximatelyl%/minute to 20%/minute, more preferably 2%/minute to 10%/minute. The stretching speed of the third stage of the three-stage stretching is preferably approximately 1%/minute to 20%/minute, more preferably 2%/minute to 10%/minute. During three-stage stretching in the MD direction, the stretching time of each stage is not particularly restricted, but is approximately 2 seconds to 5 minutes, preferably 5 seconds to 3 minutes. The pattern for longitudinal stretching and lateral stretching can be performed similar to the first manufacturing example.

The heating process and the TD stretching after the MD stretching can be performed similar to the first manufacturing example. By adjusting the stretching ratio and the residual solvent ratio within the aforementioned ranges, a film can be produced with the desired anisotropy index and that can uniformly control the dimensional variation in combination with other components requirements.

The thickness of the polyimide film of the present invention is not particularly restricted, but is preferably within a range of 1 μm or more and 100 μm or less, more preferably in a range of 5 μm or more and 50 μm or less.

The polyamide film obtained by the first manufacturing example or the second manufacturing example can be annealed if necessary. By annealing, the film can be thermally relaxed and the heat shrink ratio can be reduced. The temperature of the annealing process is not particularly restricted, but is preferably 200° C. or higher and 500° C. or lower, more preferably 200° C. or higher and 370° C. or lower, and particularly preferably 210° C. or higher and 350° C. or lower. With the polyimide film manufacturing method of the present invention, orientation in the TD direction of the film is strong, so the featuring ratio will tend to be higher in the TD direction, but the heat shrink ratio at 200° C. can be suppressed to 0.05% or less in both the MD and TD direction of the film due to thermal relaxing by the annealing process, and therefore the dimensional precision will be even higher, which is preferable. Specifically, annealing is preferably performed by passing the film in a low tensile condition through an oven at a temperature that is preferably 200° C. or higher and 500° C. or lower more preferably 210° C. or higher and 350° C. or lower, and particularly preferably 210° C. or higher and 350° C. or lower. The time that the film resides in the oven is the processing time and can be controlled by changing the travel speed, and the processing time is preferably 30 seconds to 5 minutes. If the processing time is shorter than this, sufficient heating will not occur, but if the processing time is longer, heating will be excessive and the flatness will deteriorate, which is not desirable. Furthermore, the film tensile force during travel is preferably 10 to 50 N/m, more preferably 20 to 30 N/m. If the tensile force is lower than this range, the travel properties of the film will be inferior, but if the tensile force is higher, the heat shrink ratio will be higher in the direction of travel of the film that is obtained, which is not preferable.

The heat shrink ratio of the polyimide film of the present invention is not particularly restricted, but is preferably −0.02% to +0.02%. The heat shrink ratio is determined by preparing a 20 cm×20 cm film, measuring the film dimension (L1) after sitting for 2 days in a room at 25° C. and 60% relative humidity, measuring the film dimension (L2) after heating for 60 minutes at 200° C. and then again sitting four 2 days in a room at 25° C. and 60% relative humidity, and then calculating the value using the following equation.

(Formula 2)

Heat shrink ratio (%)=−(L2−L1)/L1×100 (Formula 2)

In order for the polyamide film obtained to have adhesion, and electrical process such as corona treatment or plasma treatment of the film surface, or a physical treatment such as a blast treatment can be performed. The environmental pressure of the blast treatment is not particularly restricted, but normally is within a range of 13.3 to 1330 kPa, preferably in a range of 13.3 to 133 kPa (100 to 1000 Torr), and more preferably in a range of 80.0 to 120 kPa (600 to 900 Torr).

The environment for performing the plasma treatment contains at least 20 mol % of an inert gas, preferably contains 50 mol % or more of an inert gas, more preferably contains 80 mol % or more, and most preferably contains 90 mol% or more. The inert gas can be He, Ar, Kr, Xe, Ne, Rn, N2, or a mixture of two or more thereof. Preferably the inert gas is Ar in particular. Furthermore, the inert gas can also contain oxygen, air, carbon monoxide, carbon dioxide, carbon tetrachloride, chloroform, hydrogen, ammonia, tetrafluoromethane (carbon tetrafluoride), trichlorofluoro ethane, trifluoromethane, and the like. Examples of preferable mixed gas combinations that are used as the environment for plasma treatment of the present invention include argon and oxygen, argon and ammonia, argon and helium and oxygen, argon and carbon dioxide, argon and nitrogen and carbon dioxide, argon and helium and nitrogen, argon and helium and nitrogen and carbon dioxide, argon and helium, helium and air, argon and helium and monosilane, argon and helium and disilane, and the like.

The processing power density when performing plasma treatment is not particularly restricted, but is preferably 200 W-min/m² or higher, more preferably 500 W-min/² or higher, and most preferably 1000 W-min/² or higher. The plasmid irradiation time during plasma treatment is preferably 1 second to 10 minutes. If the plasma treatment time is set within this range, the effect of plasma treatment can be sufficiently demonstrated without degrading the film. The type of gas, gas pressure, and processing density during plasma treatment are not restricted to the aforementioned conditions, and plasma treatment can also be performed in air.

Thermoplastic polyimide is obtained by imidizing polyamic acid which is a precursor. The thermoplastic polyimide precursor is not restricted in particular, and any commonly known polyamic acid can be used. Furthermore, commonly known raw materials and reaction conditions can be used during manufacturing. Furthermore, if necessary, and inorganic or organic filler can be added.

The glass transition temperature of the thermoplastic polyimide is not particularly restricted so long as being within a range of 150° C. to 350° C.

The adhesive film of the present invention is obtained by providing an adhesive layer containing thermoplastic polyimide on at least one side of a specific polyimide film continuously produced as described above. The specific manufacturing method can be a method of forming an adhesive layer on the polyimide film that will be the substrate film, or a method of forming an adhesive layer as a sheet, and then overlaying this sheet onto the polyimide film, and the like. Of these methods, if the former method is used, the solubility in organic solvents will be reduced if all of the polyamic acid, which is the precursor of the thermoplastic polyamide included in the adhesive layer, is completely imidized, and therefore providing the adhesive layer on the polyimide film maybe difficult. Therefore, from the aforementioned perspective, a more preferable method is one where a solution containing polyamic acid which is a precursor of the thermoplastic polyamide is prepared and applied onto a substrate film, and then an imidizing procedure is performed.

The method of spreading and applying the polyamic acid solution onto the polyimide film is not particularly restricted, and existing methods can be used, such as a die coater, reverse coater, blade coater, and the like. If the adhesive layer is continuously formed, the effect of the present invention will be more pronounced. In other words, this is a method where the polyamide film obtained as described above is rolled up, and then unrolled while continuously applying a solution containing polyamic acid which is a precursor of the thermoplastic polyimide. Furthermore, the polyamic acid solution may contain other material such as fillers for example, depending on the application. Furthermore, the thickness component of each layer of the heat resistant adhesive film can be appropriately adjusted to achieve a total thickness that corresponds to the application.

The imidizing method can be either a heat imidizing method or a chemical imidizing method. If any of the imidizing procedures are used, heating is performed in order to improve the efficiency of imidizing, but the temperature at this time is preferably set to a range within glass transition temperature of the thermoplastic polyimide −100° C.) to (glass transition temperature +200° C.), and more preferably is set within a range of (glass transition temperature of the thermoplastic polyimide −50° C.) to (glass transition temperature +150° C.). Imidizing will more easily occur if the heating temperature is high, so the imidizing rate can be increased, which is favorable from the perspective of productivity. However, if the temperature is too high, the thermoplastic polyimide might thermally decompose. On the other hand, if the heating temperature is too low, imidizing will not easily proceed even with chemical imidizing, and the time required for the imidizing process will be long.

The imidizing time is not restricted in particular, so long as there is sufficient time to essentially complete imidizing and drying.

The thickness of the thermoplastic polyimide is preferably 0.1 μm or more and 10 μm or less, more preferably 0.1 μm or more and 5 μm or less.

The type of metal used in the present invention is not particularly restricted, but examples include copper and copper alloys, stainless steel and alloys thereof, nickel and nickel alloys (including 42 alloy), aluminum and aluminum alloys, and the like. Copper and copper alloys are preferable. Furthermore, a rust preventing layer, heat resistant layer (such as chrome or zinc plating), silane coupling agent, and the like can also be formed on the metal surface. Preferable metals are copper and copper alloys containing copper and at least one other components selected from nickel, zinc, iron, chrome, cobalt, molybdenum, tungsten, vanadium, beryllium, titanium, tin, manganese, aluminum, phosphorus, silicon, and the like. These materials are preferably used for circuit processing. A particularly preferable metal foil is copper foil formed by rolling or by an electroplating method, and the thickness is preferably 3 to 150 μm, more preferably 3 to 35 μm.

The metal foil may have a roughening process performed on one or both surfaces, or can be without any roughening process on either surface.

The heat and pressure bonding method of the metal and non-thermoplastic polyimide can be a method where a polyamide solution and/or polyamic acid which is a precursor of thermoplastic polyimide is applied and dried onto a non-thermoplastic polyimide film, and then overlaid with a metal, or a method where the thermoplastic polyimide is formed on the metal beforehand using a similar method, and then overlaid onto the non-thermoplastic polyimide film, and laminating can be performed by a hot press method and/or continuous lamination method. The hot press method can be performed by overlaying polyimide and the metal foil cut to a size suitable for a press, and then thermal compression bonding using a hot press.

The continuous lamination method is not particularly restricted, but an example is where a film is sandwiched between two rollers and lamination is performed. The roller can be a metal roller, rubber roller, at the like. The material is not restricted, but the metal roller can be made of steel or stainless steel. A processed roller with increased surface hardness using hard chromate plating or tungsten carbide or the like is preferably used. The rubber roller is preferably a metal roller with heat resistant silicon rubber or fluorine rubber on the surface thereof.

Furthermore, continuous lamination also known as belt lamination can be performed using a series of one or more pairs of upper and lower metal rollers, with an upper and lower seamless stainless steel belt provided between the upper and lower rollers, where the belt is pressed by the metal rollers, and is heated by the metal rollers or by another heat source.

The lamination temperature is preferably within a range of 200 to 400° C. Hot annealing is preferably performed after hot pressing and/or continuous lamination.

The flexible metal laminate plate obtained by the manufacturing method of the present invention can form wiring with a desired pattern by etching the metal foil as described above, and can be used as a flexible wiring board for mounting various types of minute and highly compact components. Naturally, the application of the present invention is not particularly restricted, and various other applications are of course possible, so long as a laminate body includes a metal foil.

### EXAMPLES

Next, the present invention is described in further detail by presenting examples, but the present invention is not restricted in any way by these examples, and many variations within the technical concept of the present invention are possible by one skilled in the art.

The measurement methods of the various properties of the present invention are described below.

### (1) A I (45, 135)

The propagation speed V of the ultrasonic pulse of the present invention was measured using a Sonic Sheet Tester SST-2500 manufactured by Nomura Trading. When using the SST-2500, the ultrasonic speed in 16 directions is automatically measured at increments of 11.25 in the surface direction 0° to 180° of the film (0° is parallel to the MD direction). From the speeds in the various directions obtained, the anisotropy index (AI) expressed by formula 1 is determined from the ultrasonic speed V45 and V135 at 45° and 135° based on the MD direction. The film obtained by the following examples and comparative examples were measured at the locations indicated in FIG. 3.

AI (45, 135)=|(V45̂2−V135̂2)/(V45̂2+V135̂2)/2)×100| (formula 1)

### (2) Orientation Angle

The orientation angle of the present invention was measured using a sonic sheet tester (SST-2500) manufactured by Nomura Trading. When using the SST-2500, the ultrasonic speed in 16 directions is automatically measured at increments of 11.25° in the surface direction 0 to 180° of the film (0° is parallel to the MD direction). A pattern diagram such as FIG. 3 is drawn by radar graphing the speed in each of the directions obtained (using the graphing function of Microsoft Excel). The line drawn from the center of the circle to the furthest section of the pattern diagram is the orientation axis (g), and the angle (θ) of the orientation axis from the baseline was measured using the MD as the baseline, to determine the orientation angle.

### (3) Dimensional Variation Ratio

Four holes were formed at the center and on diagonal lines of an adhesive film, and the distance from the center part to each hole was measured in accordance with JIS C6481 5.16. Next, copper foil was overlaid at a temperature of approximately 300 to 400°, an etching process was performed, the metal foil was removed from the flexible metal laminate plate, the same etching process as described above was performed again, and then the distance from the center part to each of the four holes was measured. If measurement value of the distance to each hole before removing the metal foil is D1, and the measurement value of the distance to each hole after removing the metal foil is D2, the dimensional variation ratio before and after etching can be determined by the following formula.

Dimensional variation ratio (%)=×100

Furthermore, the difference in the dimensional variation ratios of right 45° and left 45° was determined.

### Polyamide Synthesis Example 1

A mixture of pyromellitic dianhydride (molecular weight 218.12)/3,3′,4,4′-biphenyl tetracarboxylic dianhydride (molecular weight 294.22)/4,4′-diamino diphenyl ether (molecular weight 200.24)/paraphenylene diamine (molecular weight 108.14) was prepared at a molar ratio of 80/20/75/25, and then a 20 weight % solution in DMAc (N,N-dimethyl acetamide) was prepared and polymerized to obtain a polyamic acid solution with a viscosity of 3500 poise.

### Polyamide Synthesis Example 2

A mixture of pyromellitic dianhydride (molecular weight 218.12)/3,3′,4,4′-biphenyl tetracarboxylic dianhydride (molecular weight 294.22)/4,4′-diamino diphenyl ether (molecular weight 200.24)/paraphenylene diamine (molecular weight 108.14) was prepared at a molar ratio of 65/35/80/20, and then a 20 weight % solution in DMAc (N,N-dimethyl acetamide) was prepared and polymerized to obtain a polyamic acid solution with a viscosity of 3500 poise.

### Thermoplastic Polyimide Synthesis Example

1,3-bis-(4-amino phenoxy)benzene was added to dimethyl acetamide solvent and stirred until dissolved. Next, 4,4′-dioxydiphthalic anhydride was added and stirred to obtain a polyamic acid solution. The solid fraction of the dimethyl acetamide was 15%, and the glass transition temperature was 217° C.

### Example 1

An N,N-diethyl acetamide slurry was prepared containing silica where the particle diameter of all particles measured by a laser diffraction/diffusion type particle size distribution measuring device LA-910 (produced by Horiba Ltd.) was restricted to 0.01 μm or more and 1.5 μm or less, the average particle diameter (volumetric average particle diameter) was 0.42 μm, and the particle size distribution (volumetric basis) was such that particles with a particle diameter of 0.15 to 0.60 μm accounted for 89.9 volume % of all particles, and the slurry was added to the polyamic acid solution obtained in synthesis example 1 to make 0.4 weight % on a resin weight basis, and then sufficiently stirred and dispersed. 17 weight % of acetic anhydride (molecular weight 102.09) and 17 weight % of β-picholine were added to the polyamic acid solution, mixed, and stirred. The mixture obtained was cast on a rotating 75 ton stainless steel drum using a T-shaped slit die to obtain a self-supporting gel film with a residual volatile content of 55 weight %, and the thickness of approximately 0.05 mm. The gel film was peeled from the drum, and transported by two sets of nip rollers. At this time, longitudinal stretching was performed in two stages by changing the rotational speed of the stainless steel drum (R1), the first nip roller (R2), and the second nip roller (R3), and longitudinal stretching was performed at 65° C. so that the stretching ratios were at the values indicated in the following Table 1. After longitudinal stretching, both ends of the film were clamped and the film was processed in a heating oven at 250° C. for 50 seconds and at 400° C. for 75 seconds to obtain a polyimide film with a width of 2.2 m and a thickness of 38 μm. Lateral stretching was set to achieve a maximum value when passing through the heating oven (250° C.×50 seconds) where the solvent is removed. The stretching ratio when passing through the heating oven was the maximum stretching ratio, and the lateral stretching ratio was reduced after passing through the heating oven. The lateral stretching ratio was determined as the value where the film width of the maximum lateral stretching ratio was divided by the gel film width after peeling from the drum. The lateral stretching ratio is presented in the following Table 1. The AI (45, 135) of the polyamide film obtained was measured at the five points illustrated in FIG. 4(b, b′, c, d, d′), and is presented in the following Table 2.

### (Manufacturing Method of the Thermoplastic Polyimide Flexible Metal Laminate Plate)

Thermoplastic polyimide was applied so as to achieve a dried thickness of 2 μm onto the film fabricated in example 1, and thermal imidizing was performed for 10 minutes at 150° C. and for 1 minute at 350° C. Next, a copper foil was laminated onto the thermoplastic polyimide side to produce a flexible metal laminate plate. The dimensional variation ratio of the flexible metal laminate plate was measured before and after. The dimensional variation ratio is presented in the following Table 2.

### Examples 2 Through 4

A flexible metal laminate plate was fabricated using polyimide films obtained in a manner similar to example 1, except that the polyamic acid solution used, longitudinal stretching ratio, lateral stretching ratio, drying temperature, and film thickness were set as indicated in Table 1, after forming an adhesive film similar to example 1. The dimensional variation ratio was determined and is presented in the following Table 2.

### Comparative Examples 1 and 2

A flexible metal laminate plate was fabricated using polyimide films obtained in a manner similar to example 1, except that the polyamic acid solution used, longitudinal stretching ratio, lateral stretching ratio, drying temperature, and film thickness were set as indicated in Table 1, after forming an adhesive film similar to example 1. The dimensional variation ratio was determined and is presented in the following Table 2.

Results are shown in Table 1 below.

TABLE 1

| Polyamic acid | | | | | Comparative | Comparative |
|---|---|---|---|---|---|---|
| solution | Example 1 | Example 2 | Example 3 | Example 4 | Example 1 | Example 2 |
| Longitudinal | 1.05 | 1.08 | 1.07 | 1.08 | — | 1.05 |
| stretch factor (first | | | | | | |
| stage) (R2/R1) | | | | | | |
| Longitudinal | 1.04 | 1.07 | 1.06 | 1.08 | — | 1.04 |
| stretch factor | | | | | | |
| second stage) | | | | | | |
| (R3/R2) | | | | | | |
| Longitudinal | 1.09 | 1.16 | 1.13 | 1.17 | 1.12 | 1.09 |
| stretch factor | | | | | | |
| (R3/R1) | | | | | | |
| Lateral stretch | 1.52 | 1.48 | 1.50 | 1.49 | 1.45 | 1.40 |
| factor | | | | | | |
| Residual solvent | 70% | 80% | 80% | 85% | 80% | 45% |
| ratio at 50% | | | | | | |
| lateral stretching | | | | | | |
| Residual solvent | 50% | 60% | 60% | 65% | 60% | 10% |
| ratio at 80% | | | | | | |
| lateral stretching | | | | | | |
| Film thickness | 20 | 50 | 20 | 5 | 20 | 20 |
| (μm) | | | | | | |

TABLE 2

| | Al | Dimensional | Dimensional | Difference in |
|---|---|---|---|---|
| | (45, | variation ratio | variation ratio | dimensional |
| | 135) | (right 45°) | (right 45°) | variation ratios |
| Example 1 | | | | |
| b | 7.9 | 0.031 | 0.027 | 0.004 |
| b′ | 5.0 | 0.023 | 0.020 | 0.003 |
| c | 3.6 | 0.020 | 0.018 | 0.002 |
| d | 2.8 | 0.018 | 0.014 | 0.004 |
| d′ | 10.3 | 0.043 | 0.040 | 0.003 |
| Example 2 | | | | |
| b | 5.3 | 0.022 | 0.020 | 0.002 |
| b′ | 2.3 | 0.016 | 0.015 | 0.001 |
| c | 1.6 | 0.014 | 0.014 | 0.000 |
| d | 2.8 | 0.011 | 0.013 | 0.002 |
| d′ | 3.6 | 0.020 | 0.016 | 0.004 |
| Example 3 | | | | |
| b | 9.1 | 0.038 | 0.040 | 0.002 |
| b′ | 4.3 | 0.015 | 0.018 | 0.003 |
| c | 1.6 | 0.014 | 0.016 | 0.002 |
| d | 3.8 | 0.012 | 0.010 | 0.002 |
| d′ | 10.6 | 0.041 | 0.040 | 0.001 |
| Example 4 | | | | |
| b | 6.0 | 0.024 | 0.022 | 0.002 |
| b′ | 3.2 | 0.015 | 0.013 | 0.002 |
| c | 0.8 | 0.007 | 0.010 | 0.003 |
| d | 2.7 | 0.012 | 0.015 | 0.003 |
| d′ | 5.5 | 0.020 | 0.022 | 0.002 |
| Comparative | | | | |
| Example 1 | | | | |
| b | 15.3 | 0.067 | 0.064 | 0.003 |
| b′ | 5.2 | 0.022 | 0.023 | 0.001 |
| c | 3.5 | 0.020 | 0.018 | 0.002 |
| d | 4.8 | 0.018 | 0.020 | 0.002 |
| d′ | 16.0 | 0.065 | 0.061 | 0.004 |
| Comparative | | | | |
| Example 2 | | | | |
| b | 12.8 | 0.058 | 0.060 | 0.002 |
| b′ | 3.9 | 0.022 | 0.021 | 0.001 |
| c | 2.0 | 0.011 | 0.008 | 0.003 |
| d | 4.2 | 0.018 | 0.016 | 0.002 |
| d′ | 12.2 | 0.052 | 0.054 | 0.002 |

From the foregoing results, it was confirmed that the polyimide film of the present invention could suppress dimensional variation and could also reduce the variation in the dimensional variation ratio at different locations in the film. On the other hand, with comparative examples 1 and 2, the dimensional variation could not be suppressed to the level of the polyamide film of the present invention, and variation was also observed in the dimensional variation ratio at different locations in the film.

### (Field of Industrial Use)

The polyimide film of the present invention is useful as a flexible print wiring board.

### EXPLANATION OF REFERENCE SYMBOLS

a polyimide film width

b point 0 mm in from the film width edge

b′ point 200 mm in from the film width edge

c point within 200 mm of the center part of the film width

d arbitrary point on a line that connects points b and b′

d′ arbitrary point on the line that connects points b and b′

e polyimide film

f center value of orientation angle measurement

g orientation axis

h orientation angle (θ)

i ultrasonic speed at each angle

What is claimed is:

1. A polyimide film comprising a manufacturing film width of 1 m or more; an anisotropy index (AI) expressed by formula 1 below of 12 or less across the entire width, when the propagation speed V of an ultrasonic pulse is measured at an orientation angle (θ) of the film of 45° and 135°, based on the machine conveyance direction (MD) of the film; and a thermoplastic polyimide layer with a thickness of 0.5 to 20 μm provided on at least one surface;
AI (45, 135)=|(V45̂2−V135̂2)/(V45̂2+V135̂2)/2)×100| (formula 1).

2. The polyimide film according to claim 1, wherein two points are selected 200 mm in from both ends of the film width in a straight line in a direction perpendicular to the machine conveyance direction (MD) of the film, one point is selected within ±200 mm of the center part of a line that includes the aforementioned two points, and another two arbitrary points are selected, and the anisotropy Index (AI) is 12 or less for at least all of these five points.

3. The polyimide film according to claim 1, wherein the polyimide film is stretched by biaxial stretching in the machine conveyance direction (MD) and the transverse direction (TD) of the film, and stretching in the MD direction is two stage stretching.

4. The polyimide film according to claim 3, wherein during the two-stage stretching in the MD direction, the ratio of the stretch factor of the first stage with regards to the total stretch factor in the MD direction is 40% or higher.

5. The polyimide film according to claim 3, wherein the stretch factor in the TD direction is 1.10 times or more to 1.5 times or less than the total stretch factor in the MD direction.

6. The polyimide film according to any one of claims 1, wherein the polyimide film is derived from an aromatic amine component where the molar ratio of 4,4′-diamino diphenyl ether and/or 3,4′-diamino diphenyl ether and paraphenylene diamine is in a range of 69/31 to 90/10, and a polyamic acid containing an acid anhydride component where the molar ratio of pyromellitic acid dianhydride and 3,3′,4,4′-biphenyl tetracarboxylic acid dianhydride is in a range of 80/20 to 60/40; or is derived from polyamic acid having an aromatic diamine component that is paraphenylene diamine and an acid anhydride component that is 3,3′,4,4′-biphenyl tetracarboxylic acid dianhydride where the molar ratio between the aromatic diamine component and the acid anhydride component is in a range of 40/60 to 60/40.

7. An adhesive polyimide film obtained by applying, heating, and drying an organic solvent solution of thermoplastic polyimide or an organic solvent solution of polyamic acid, which is a precursor of thermoplastic polyamide, onto the polyimide film according to claim 1.

8. A flexible metal laminate plate, obtained by pasting a metal foil onto the adhesive polyimide film of claim 7.
